(19) United States
(12) Patent Application Publication
(10) Pub. No.: US 2012/0290203 A1
(43) Pub. Date: Nov. 15, 2012

(54) REAL-TIME ROUTE OPTIMIZATION FOR REAL ESTATE OPEN HOUSE TOURS

(76) Inventor: Lance R. King, San Francisco, CA (US)

(21) Appl. No.: 13/471,177

(22) Filed: May 14, 2012

Related U.S. Application Data
(60) Provisional application No. 61/485,916, filed on May 13, 2011.

(51) Int. Cl. G01C 21/00

(52) U.S. Cl. 701/430; 701/533

(57) ABSTRACT

A system and method are disclosed for optimizing a route and schedule for visiting real estate open houses. The system may update the route and schedule in real time where a user deviates from the provided route and schedule. The system and method may further receive notes from a user while at an open house, and automatically store those notes in association with a property where the notes were received.

### PRIORITY DATA

The present application claims priority to U.S. Provisional Patent Application No. 61/485,916, filed May 13, 2011, entitled REAL-TIME ROUTE OPTIMIZATION FOR REAL ESTATE OPEN HOUSE TOURS, which application is incorporated by reference herein in its entirety.

### BACKGROUND

Real estate sellers, buyers and agents rely on open houses as a valuable tool in the sale and purchase of residential homes. During an open house, prospective buyers tour a property for sale to learn firsthand whether it is a property they would be interested in owning. Open houses typically occur once or twice a week, coordinated to be on the same day, so that interested buyers can attend multiple open houses. The open houses typically occur on these days during some common time window, although some may begin before, or end after, the most common time window. As such, buyers who wish to attend multiple open houses on a given day and during a given time window need to efficiently coordinate their schedules. Even where a schedule of open houses starts out as optimized, schedules often get thrown off kilter, and there is often a need to make real-time schedule adjustments with regard to the remaining planned open house visits.

### BRIEF DESCRIPTION OF THE DRAWINGS

FIG. 1 is a flowchart of the operation of a first embodiment of the present system.

FIG. 2 is a flowchart of step 214 of FIG. 1.

FIG. 3 is a flowchart of the operation of a further embodiment of the present system.

FIG. 4 is a flowchart of step 274 of FIG. 3.

FIGS. 5A and 5B are a flowchart of an embodiment for dynamically updating an optimized schedule based on a user running late or early relative to an earlier generated schedule.

FIG. 6 is a block diagram of a sample computing device on which embodiments of the present system may be implemented.

### DETAILED DESCRIPTION

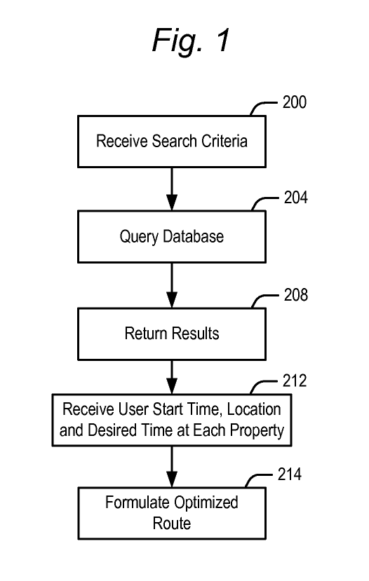

Embodiments of the present technology will now be described with reference to FIGS. 1-6, which in general relate to a system for optimizing a schedule for visiting real estate open houses. It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

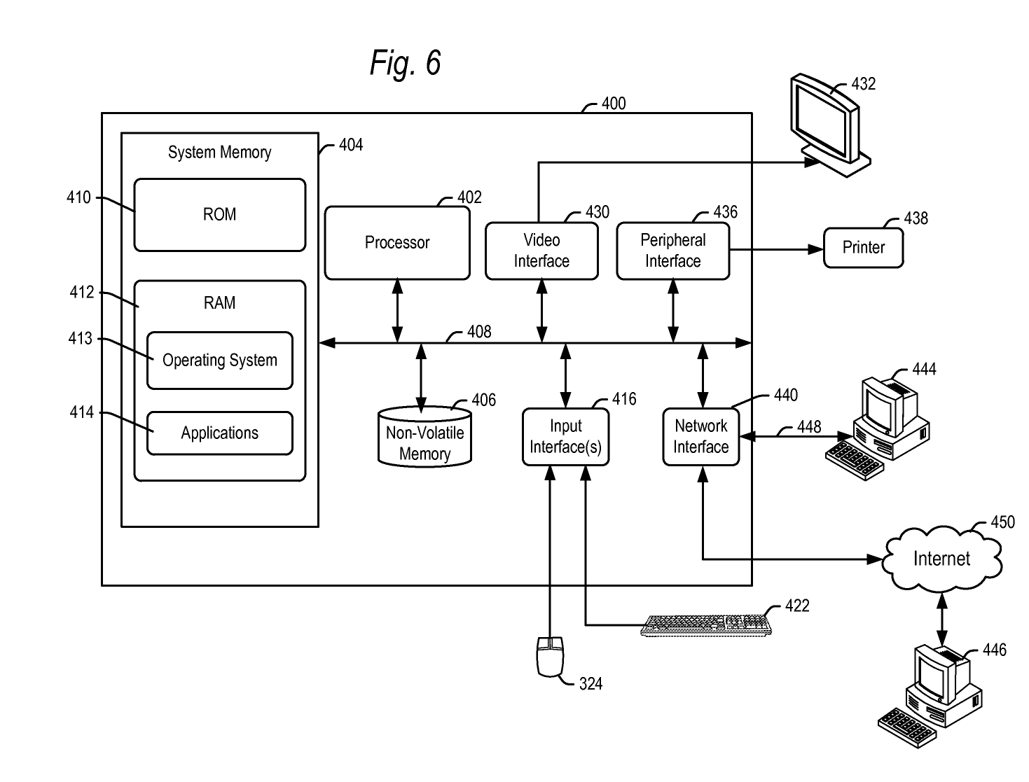

FIG. 1 is a high level flowchart of an embodiment of the present system. The present system may be implemented by a scheduling algorithm executing on any of various computing devices, including for example desktop computers, laptop computers, tablets, cellular telephones, hand-held mobile devices, television/set top boxes, video game consoles, automobiles and smart appliances. An example embodiment of a computing device for performing the present technology is explained in greater detail below with respect to FIG. 6. In step 200, a user enters search criteria for the open houses that the user would like to visit on a given day. As noted in the Background section, open houses may be on a given day and during a time window, referred to herein as the open house time period. A user may perform step 200 in advance of the open house time period, just prior to the open house time period, or (as explained below) during the open house time period.

The user's search criteria are used to query a database in step 204 which returns the open houses that satisfy the search criteria in step 208. The database returns at least the locations of the open houses and the scheduled times and dates of the open houses. The database may return additional information such as property descriptions, price, etc. Such databases containing open houses which are searchable by user-provided criteria are known. Examples of such systems are shown in U.S. Pat. No. 6,910,045, entitled “Automatic Data Transmission in Response to Content of Electronic Forms Satisfying Criteria,” issued Jun. 21, 2005; and the SFARMLS on-line website by the San Francisco Association of Realtors and the Rapattoni Corporation, San Francisco, Calif.—http://www.sfarmls.com; both of which systems are incorporated by reference herein in their entirety.

In step 212, the scheduling algorithm may then receive additional information that will enable the application to formulate an optimized open house route itinerary. This additional information includes for example a selection of some or all of the open house results returned from the database meeting the search criteria. The additional information may further include the time and place from which the user is to begin visiting the open houses. The additional information may further include how much time the user wishes to spend at each location. The user may specify one time period, which will then be used for the length of stay at each location, or the user may specify different time periods for two or more of the properties that the user wishes to visit. The user may provide additional information in step 212.

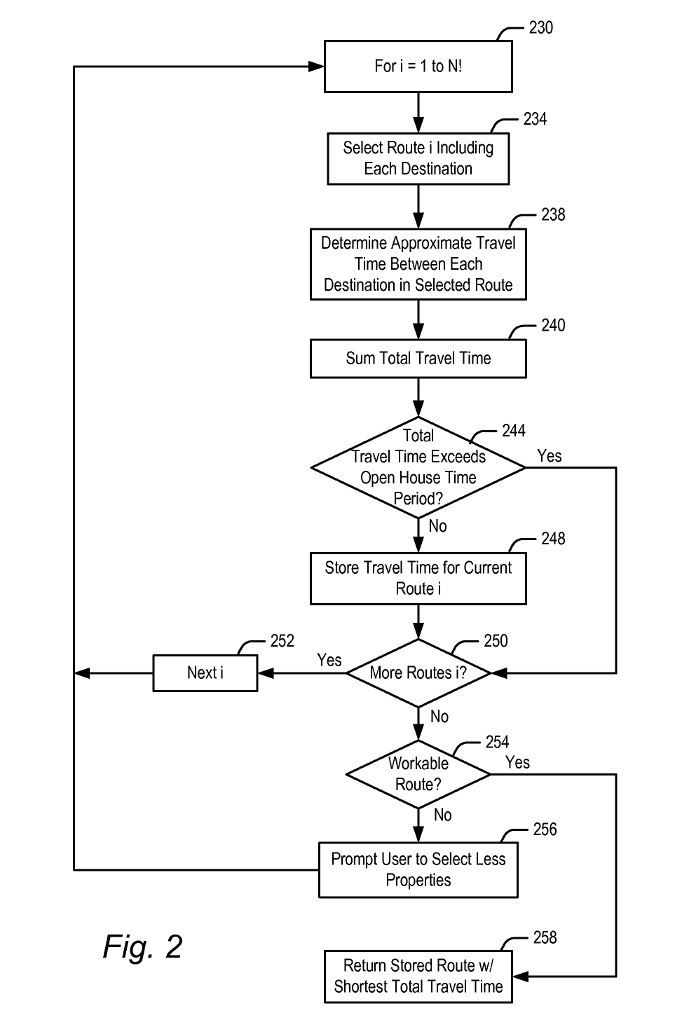

In step 214, the scheduling algorithm formulates an optimized route for a user to travel in visiting his or her selected open houses. Further details of step 214 are shown in the flowchart of FIG. 2. Where a user has selected N properties that he or she wishes to visit, there are N! (N factorial) possible routes by which a user may travel to reach each of the N properties. The scheduling algorithm analyzes each possible route and determines the route which will allow the user to travel between each of the properties in the minimum amount of time.

In step 230, the system begins a “for/next” loop for i=1 to N! possible driving routes, where N is the number of properties the user wishes to visit in a given open house time period on a given day. As indicated, N! represents all possible permutations of routes that the user can take to visit each of the properties the user has selected. In step 234, the algorithm begins by selecting a first route (i=1) including each of the properties the user wishes to visit.

The system may select the different routes randomly or by some hierarchy, but in embodiments would include all possible route permutations N!.

In step 238, the system determines the approximate driving time to reach each of the selected properties using the first selected driving route (i=1). Various system are known for mapping two or more addresses, and determining the approximate travel time between each of the mapped addresses. Such systems include for example the “Get Directions” option in Google Maps, an online website by Google Inc., Mountain View, Calif.—http://maps.google.com/maps?hl=en&tab=wl, which system is incorporated by reference herein in its entirety. Such systems take into account not just geographic distances between addresses, but also the average speed with which a user would drive on the roads from the first address to the second address. Thus, in embodiments, the present system minimizes the time to drive between each of the selected properties by taking into account both geographic distances between each of the properties and also the average speed that a user would drive on the route between the selected properties. In further embodiments, the system may only consider the distances between the properties when optimizing the route.

In step 240, the scheduling algorithm sums the total drive time between each of the selected properties in the first route (i=1). In step 244, the algorithm checks whether the summed drive time exceeds the open house time period. For example, running through all possible permutations i=1 to N! for visiting each of the selected properties, some of the permutations will be extremely inefficient, possibly taking the user for example from their start location to the farthest property and then back to a second property right near the user's start location.

If the calculated drive time to each selected destination in a particular permutation does not exceed the total open house time period, that route and the travel time required for the route are stored in memory associated with the user's computing device in step 248. On the other hand, if a permutation i includes many inefficient travel legs in the route so that the travel time exceeds the available time in the open house time period, that permutation i is not stored. Moreover, a user may have selected so many open houses to visit, it is not possible to drive between them in the allotted open house time period, using even the most efficient driving route. In such an embodiment, none of the routes are stored.

In step 250, the algorithm checks whether there are more routes i to check (i<N). If so, i is incremented in step 252 and the algorithm returns to step 230 to check the next possible permutation. Assuming the user has selected more than one open house to visit, the first time through the loop, there will be further possible routes to examine in step 250.

Once the algorithm has examined all possible routes (i=N), the algorithm will exit the loop in step 250 and check in step 254 whether any workable routes were identified and stored. If no route was found that can be driven between the start and end of the open house time period, the system will prompt the user to select fewer open house destinations in step 256. The system will then return to step 230 to perform the route optimization analysis again.

On the other hand, if one or more routes were returned and stored that can be traveled within the allotted open house time period, the route with the shortest time period is selected in step 258. This route is returned to the user, together with the drive time to each selected open house. The user may then store that route, or forward it to a printer or another computing device.

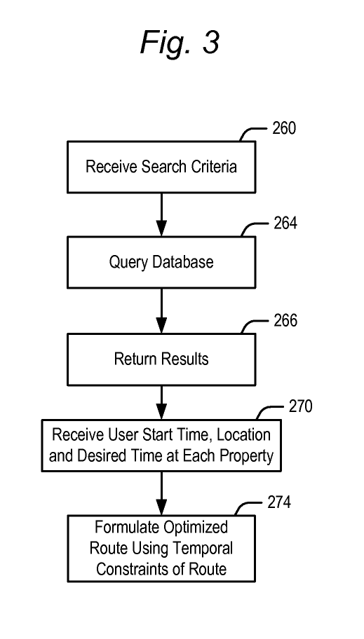

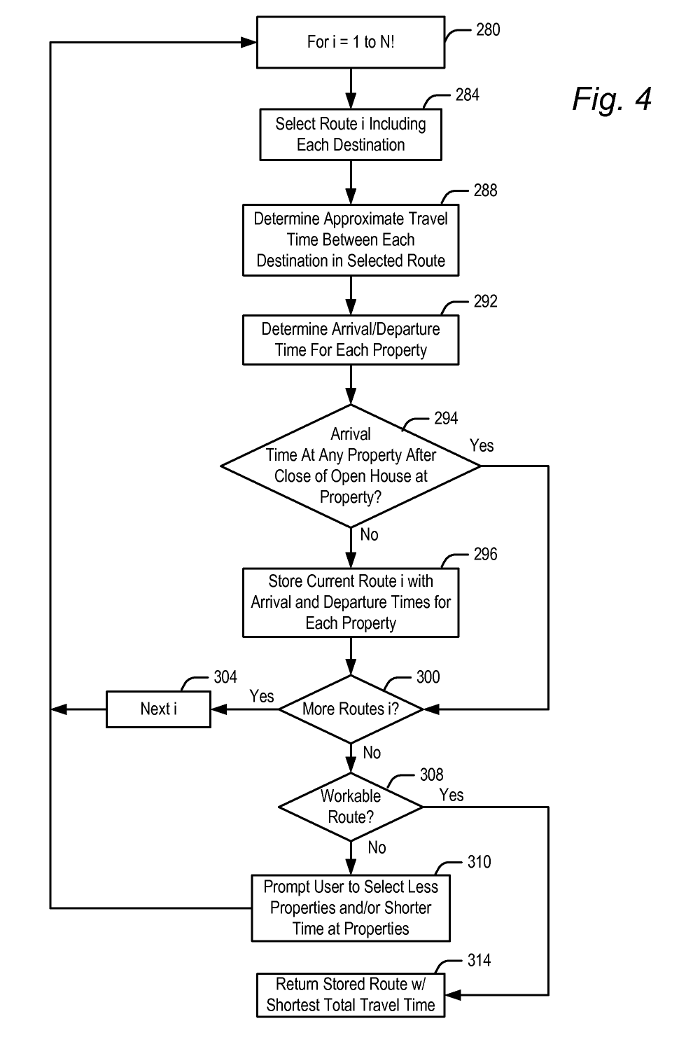

The flowcharts of FIGS. 1 and 2 are a straightforward determination of an optimized route which does not take into consideration the time a user would like to spend at each property. The flowcharts of FIGS. 3 and 4 are similar to the flowcharts of FIGS. 1 and 2 with the change that time at each property is factored in. FIG. 3 shows steps 260 through 270 as described above of receiving the search criteria; querying the database; returning the results; and receiving user information relating at least to selected properties, start time and location, and desired time at each property. In step 274, the scheduling algorithm formulates an optimized route taking into consideration drive time between each of the selected properties and temporal constraints such as desired time at each property.

The flowchart of FIG. 4 shows further details of step 274 and is similar to FIG. 2. In step 280, the “for/next” loop begins for all possible route permutations i=1 to N! for the selected number of properties N. A particular route i is selected in step 284. The travel time between each property in route i is determined in step 288 as described above. In step 292, the example embodiment of FIG. 4 determines the arrival and departure times for each property in the selected route. Step 292 uses the starting time when the user leaves his or her home location, the driving time to each property and the length of time the user wishes to stay at each property. As noted above, the length of time at each property may be the same, or may be customized to vary from property to property. Moreover, as explained below, the schedule may be dynamically updated in real time to reflect drive times or stays at open houses that are longer or shorter than provided by the optimized schedule.

In step 294, the algorithm determines whether the arrival time at any property occurs after the close of the open house at that property. In particular, the algorithm keeps a running time from the start time including all driving time to each property and the desired length of stay at each property. If the running time is such that the arrival time at a given property using a given route i occurs later than the close of the open house at that property, the route is not stored as a viable route option. This step takes into consideration not only the drive time between each open house, but also that some open houses may close earlier than other open houses. Assuming that all destinations are arrived at in the route i before the close of the open houses at each of the destinations, that route i is stored in step 296, together with the arrival and departure times from each destination in that route.

In step 300, the algorithm checks whether there are additional route permutations. If so, i increments in step 304 and the next route are checked. If all routes have been analyzed in step 300, the algorithm next checks in step 308 whether any workable routes were identified; that is, any routes in which all destinations were arrived at prior to the close of the open house at each destination. If not, the user is prompted in step 310 to reduce the number of destinations and/or reduce the time the user stays at each destination.

On the other hand, if one or more routes were returned where each destination is arrived at prior to the close of the open house at that destination, the route which takes the shortest overall time is selected in step 314. This route is returned to the user, together with the arrival and departure times at each selected open house.

It is understood that the above-described methods are merely some of the methods that may be used to calculate an efficient travel route for viewing open houses. It is understood that a variety of other methods and heuristics may be employed for optimizing the travel route in other ways or for further honing the route.

As noted, the above steps may be performed far in advance of the scheduled open house date or right up to the time of the open house time period. Moreover, the present algorithm can further be used in real time, dynamically changing as a user's demands change. It may be that, after an optimized route is determined by the above methods, a user wishes to alter the route to omit certain open houses or add others. It may further be that a user has spent more time at one open house than originally anticipated, thereby putting them off the determined optimized schedule. In accordance with the present system, the optimized schedule may be continuously altered and updated to fit the user's needs.

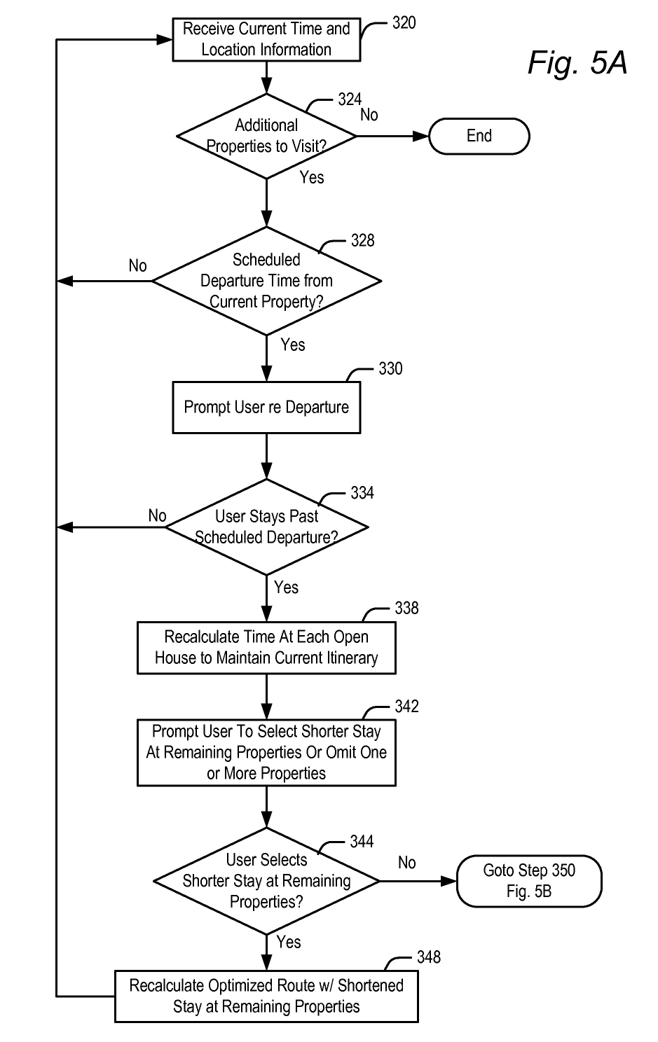

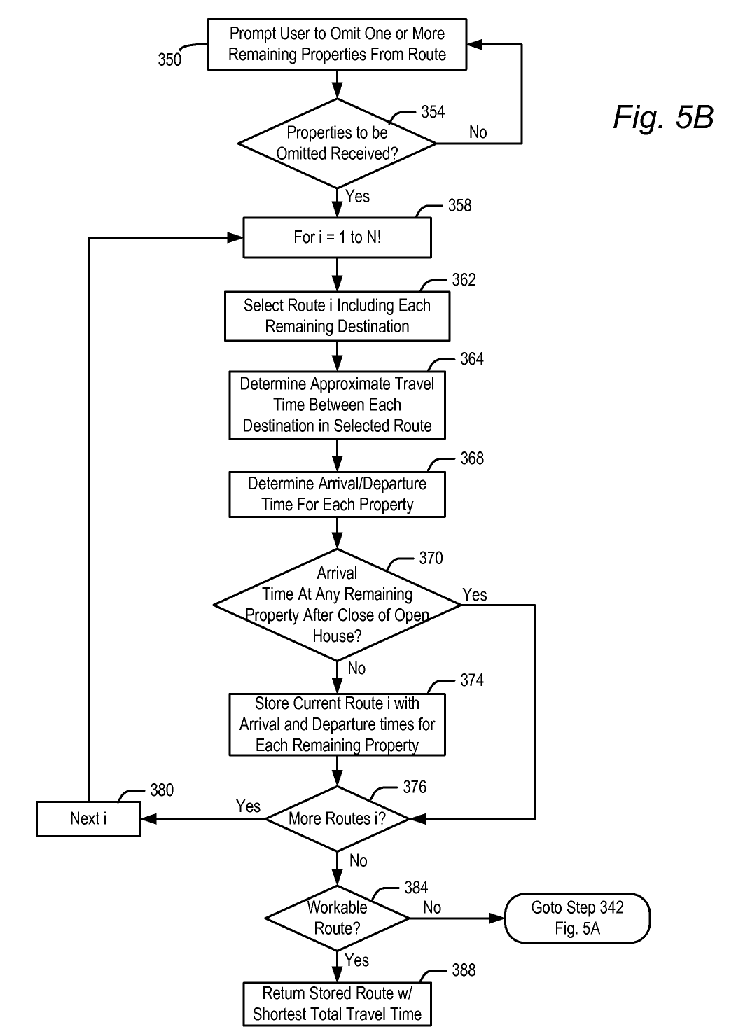

FIGS. 5A and 5B show an embodiment for dynamically updating an optimized schedule per the present system. The embodiment described assumes that the scheduling algorithm has access to the user's changing geographic location. This may be provided in a variety of ways. For example, many computing devices have a GPS (Global Positioning System) receiver for identifying the location of the computing devices. Other methods, such as coming within range or leaving the range of a cellular network and/or mobile network, may also provide or confirm position of a mobile computing device. Where no automated position-detection system is available, a user may periodically manually update their location.

In step 320, the algorithm receives the current time and location from the computing device on which it is running In step 324, the algorithm checks whether there are additional open houses that the user has scheduled to visit. If not, the algorithm ends. Assuming there are additional locations to visit, the algorithm checks in step 328 whether the current time is the scheduled departure time from the current open house. As is known, the presence of the user at a particular open house may be provided by the GPS or other position-detection system. If it is not yet time to depart the current location according to the optimized schedule, the algorithm returns to step 320 to again retrieve current time and location information.

On the other hand, assuming the algorithm detects that it is time to leave the current open house if the user is to stay on the optimized schedule, the algorithm can cause a prompt to be given to the user in step 330. The prompt may for example indicate that it is time to leave the current location. Warning prompts may also be provided, for example 5 minutes before the scheduled departure time from the current location. Although not shown in the figures, using the positioning system associated with the user's computing device, the algorithm may detect when a user is approaching a scheduled open house, and display or audibly present information on the open house that the user is about to arrive at.

In step 334, the algorithm detects whether the user has stayed at a given location past the scheduled departure time. Step 334 may further detect whether the travel route has taken longer than expected, due for example to traffic or the user diverting off of the scheduled route. If that occurs in step 334, the algorithm recalculates the time allowed at each remaining open house on the scheduled route in step 338 to maintain the current itinerary. After 338 is performed, the algorithm may prompt the user to select a shorter stay at the remaining open houses, or to omit one or more of the remaining open houses.

If a user selects a shorter stay at the remaining properties in step 344, the algorithm recalculates the route with shortened stays at one or more of the remaining properties and presents the revised schedule to the user. The user can manually edit the route provided by the algorithm to shorten or lengthen a stay at one of the remaining open houses.

While the embodiment described above covers a situation where a user is running late relative to the optimized schedule, the optimized schedule may similarly be dynamically modified in real time where a user is running ahead of schedule. In particular, where drive times and/or stays at open houses are shorter than anticipated in the optimized schedule, the algorithm may recalculate the optimized schedule to shift all remaining open house travel and stays to be earlier in time. Alternatively, the system may prompt the user as to whether to dynamically modify the optimized schedule in this manner.

In embodiments where the user is running late, if the user elects to omit one or more of the remaining properties in step 344, instead of shortening the stay at the remaining open houses, the algorithm then prompts the user to indicate which of the remaining open houses the user wishes to omit in step 350 (FIG. 5B). The algorithm may present the user with a graphical user interface allowing the user to select one or more of the remaining properties to omit (or de-select one or more of the remaining properties). In step 354, the algorithm checks whether the user has omitted one or more of the remaining properties. If not, the algorithm returns to step 350 to again prompt the user.

If the user has omitted one or more remaining properties, the algorithm dynamically recalculates an optimized route on the remaining properties, for example as described above with respect to the flowchart of FIG. 4. In particular, the algorithm executes a “for/next” loop from i=1 to N! in step 358, where N is the number of open houses remaining to visit after modification by the user. In step 362, a route i is selected starting at the current location and including each remaining open house destination. In step 364, the algorithm determines the approximate travel time between each destination in the selected route i. In step 368, the algorithm determines the arrival and departure times for each property remaining in the user's open house tour.

In step 370, the algorithm checks whether the arrival time at any remaining property for the route i occurs after the scheduled close of the open house at that property. If all destinations for the route i are arrived at before the close of the open houses at each of the destinations, that route i is stored in step 374, together with the arrival and departure times from each remaining destination in that route.

In step 376, the algorithm checks whether there are additional route permutations. If so, i increments in step 380, and the next route are checked. If all routes have been analyzed in step 376, the algorithm next checks in step 384 whether any workable routes were identified; that is, any routes in which all destinations were arrived at prior to the close of the open house at each destination. If not, the algorithm returns to step 342 (FIG. 5A), where the user is again prompted to reduce the length of stay at the remaining open houses or reduce the number of destinations remaining in the open house tour.

On the other hand, if one or more routes were stored where each remaining destination is arrived at prior to the close of the open house at that destination, the route which takes the shortest overall time is selected in step 388. This route is returned to the user, together with the arrival and departure times at each selected open house.

It is understood that the above-described methods for dynamic update of a scheduled open house tour are merely some of the methods that may be used. A variety of other methods and heuristics may be employed for dynamically changing and optimizing the travel route in other ways or for further honing the route. Moreover, while the embodiment described above dynamically alters the route to reduce the number of properties, the above steps may be used to add properties. The algorithm will dynamically update, and if it is possible to fit in a tour of all properties within the allotted time, the algorithm will return an optimized route to each property.

In a further aspect of the present technology, the system may include a real-time notes and database update application, used in conjunction with a GPS system. In embodiments, when a user creates an itinerary of open houses to visit, data relating to each of the homes to be visited may be added to and saved within a database, under a separate record for each home. The data may include a variety of information, including for example the address of the home, the time and date of the planned visit, what number stop that is relative to all of the open house stops to be made on a given day, as well as a variety of information from the listing of the home, such as for example price, bedrooms, bath, layout, etc. The database may be a relational database which allows searching of the database by key term or other metric.

Thereafter, when the user's computing device senses that a user is visiting an open home on his itinerary (i.e., the GPS receiver in the user's device detects that the user is within a predefined vicinity of a home on the itinerary), the user's computing device may access the record for that home. The information for that home may then be displayed on a user interface via a variety of applications capable of displaying the record data in a user friendly format. Information indicating that a user in fact visited a given home may also be stored in the data record for that home.

If one or more of the open houses that a user was scheduled to visit get removed from the itinerary for any reason, that information may also be stored in association with the record for the home(s) that were not visited. A reason may also be entered as to why the home was not visited. The reason may be manually entered, or it may be automatically entered, for example where a home was bounced from the itinerary upon a dynamic update of the open house itinerary.

The present system further includes a real-time note-taking aspect. As explained above, a user's computing system may automatically determine when a user has arrived at a given open house destination via the user's GPS receiver. While at that location, the application may allow the user to record verbal and/or written notes relating to the user's contemporaneous impressions of the home, or any other notes the user chooses to make.

All audio and/or written notes recorded while at a home will be stored in association with the data record for that home. Audio data may be stored as an audio file. Alternatively, a speech recognition program may be used to transcribe the audio into a text file. Written notes may be stored as text files. In embodiments, the text files may be searchable in a key word search.

If a user visits a given house again, the data record for that house may be accessed, and supplemented with any additional information from the follow-up visit(s). Thus, a user may have recorded notes (audio and/or text) relating to all history a user has with a given home. The contemporaneous impressions recorded while at a home may also be valuable to a user, as a user may often forget a contemporaneous impression of a given home after a whole day of visiting open houses.

In a further aspect of the present system, the notes from a number of users may be uploaded to a central server. In this way, patterns relating to a given home may emerge which may prove useful in a variety of ways. For example, it may turn out that a number of users had the same impression of a home (or an aspect of a home), either positive or negative. Where positive, a broker may use this information to try and create that impression at the broker's other listings. Where negative, a broker may take steps to remedy the aspect leading to negative impressions. The notes from a variety of users may be used to identify trends in user impressions; that is, real time feedback on what users are then interested in or not interested in. The data from a number of users may be reviewed manually, or an application may be provided which can review the notes and identify common words or impressions.

As noted, the algorithm described above may execute on any of various computing devices. FIG. 6 shows some components of a sample computing device 400. Components of computing device 400 may include, but are not limited to, a processor 402, a system memory 404, memory 406, various system interfaces and a system bus 408 that couples various system components. The system bus 408 may be any of several types of bus structures including a memory bus or memory controller, a peripheral bus, and a local bus using any of a variety of bus architectures.

The system memory 404 includes computer storage media in the form of volatile and/or nonvolatile memory such as ROM 410 and RAM 412. RAM 412 may contain an operating system 413 for computing device 400, and applications 414 such as the scheduling algorithm described above. Non-volatile memory 406 may for example be a hard drive, semiconductor memory, or other computer-readable media. The computing device 400 may also include a variety of other computer-readable media, including removable/non-removable, volatile/nonvolatile computer storage media.

The computing device 400 may include a variety of interfaces for the input and output of data and information. Input interface 416 receives data from input devices such as a keyboard 422 and mouse 424. The input interface 416 may receive information from other devices, such as a keypad and/or touch screen.

A video interface 430 may be provided for interfacing with a monitor 432. Monitor 432 may for example be used to provide a graphical user interface to the user. A peripheral interface 436 may be provided for supporting peripheral devices, including for example a printer 438.

The computing device 400 may operate in a networked environment via a network interface 440 using logical connections to one or more remote computers 444, 446. The logical connection to computer 444 may be a local area connection (LAN) 448, and the logical connection to computer 446 may be via the Internet 450. Other types of networked connections are possible. While computers 444 and 446 are shown as desktop computers, they may be any of the above-described computing devices 400.

It is understood that the above description of computing device 400 is by way of example only, and may include a wide variety of other components in addition to or instead of those described above.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed:

1. A method for optimizing a travel route and schedule of destinations and storing notes in association with one or more destinations, comprising:
(a) receiving user input on destinations the user would like to visit;
(b) optimizing a travel route and schedule of the destinations, using a geographic map of the area of destinations and a predetermined estimate of time of travel between the destinations;
(c) adjusting the travel route optimized in said step (b) in real time where the user spends longer than scheduled at a destination or omits one of the destinations;
(d) receiving notes while at a destination; and
(e) storing the notes in association with the destination in a central database.

2. The method of claim 1, wherein the notes received in said step (d) are automatically associated with the destination for storing in said step (e).

3. The method of claim 1, wherein the notes received in said step (d) are stored in real time in said step (e).

4. The method of claim 1, wherein the notes are stored as an audio file in the central database.

5. The method of claim 1, wherein the notes are received as an audio file, transcribed, and stored as a text file in the central database.

6. The method of claim 1, further comprising the step of using a global positioning system to identify a position of the user in route to a destination.

7. The method of claim 7, further comprising the step of notifying a user when the user has arrived at a destination.

8. The method of claim 7, further comprising the step of providing information to the user regarding a destination when the user has arrived at a destination.

9. The method of claim 1, wherein the user leaves a destination and returns to the destination, the method further comprising the steps of:
receiving additional notes upon returning to the destination;
appending the additional notes to notes stored in association with the destination when the user first visited the destination.

10. A method for optimizing a travel route and schedule of destinations and storing notes in association with one or more destinations, comprising:
(a) receiving user input on destinations the user would like to visit;
(b) optimizing a travel route and schedule of the destinations, using a geographic map of the area of destinations and a predetermined estimate of time of travel between the destinations;
(c) receiving notes from a plurality of users when the users are at a given destination;
(d) storing the notes from the plurality of users in association with the given destination in a central database; and
(e) providing feedback on the given destination based on the notes from the plurality of users.

11. The method of claim 10, further comprising the step of optimizing a travel route and schedule of the destinations for a user, using a geographic map of the area of destinations and a predetermined estimate of time of travel between the destinations.

12. The method of claim 10, wherein the notes received in said step (d) are automatically associated with the destination for storing in said step (e).

13. The method of claim 10, wherein the notes received in said step (d) are stored in real time in said step (e).

14. The method of claim 10, wherein the feedback provided in said step (e) may be updated in real time based on notes received from the plurality of users in said step (c).
